(19) United States
(12) Patent Application Publication
(10) Pub. No.: US 2015/0066660 A1
(43) Pub. Date: Mar. 5, 2015

(54) Dynamic Placement Opportunity Pricing

(71) Applicant: clypd, inc., Lexington, MA (US)

(72) Inventor: Jason Burke, Boston, MA (US)

(73) Assignee: clypd, inc., Lexington, MA (US)

(21) Appl. No.: 14/169,496

(22) Filed: Jan. 31, 2014

Related U.S. Application Data
(60) Provisional application No. 61/870,377, filed on Aug. 27, 2013.

(51) Int. Cl. G06Q 30/02

(52) U.S. Cl. CPC G06Q 30/0275
USPC 705/14.71

(57) ABSTRACT

A computer system dynamically generates pricing data, such as bid floor prices and/or bid prices, for advertisement placement opportunities based on attributes of inventory sources (e.g., televisions and computers) and of the environment associated with the instance of viewership for delivery of advertisements to those advertisement placement opportunities. An example of such attributes are attributes of the content currently being delivered by the inventory sources. The computer system enables such pricing data to more accurately reflect the value of the environment for placing advertisements.

### BACKGROUND

In traditional print advertising, the location of an advertisement, such as its location within a particular section or its position on a particular page, can affect the rates at which publishers sell the ad slots and the prices willing to be paid by advertisers for such ad slots. In traditional television advertising, the position (e.g., coordinates) of an advertisement on the television screen has not played a role in pricing because traditional television advertisements occupy the entire screen. These features of traditional print advertising and traditional television advertising are not necessarily present in the context of modern television advertising, online advertising, and other current forms of advertising. As a result, traditional advertising models are not always well-suited for advertising in connection with modern media.

### SUMMARY

A computer system dynamically generates pricing data, such as bid floor prices and/or bid prices, for advertisement placement opportunities based on attributes of inventory sources (e.g., televisions and computers) and of the environment associated with the instance of viewership for delivery of advertisements to those advertisement placement opportunities. An example of such attributes are attributes of the content currently being delivered by the inventory sources. The computer system enables such pricing data to more accurately reflect the value of the environment for placing advertisements.

Other features and advantages of various aspects and embodiments of the present invention will become apparent from the following description and from the claims.

### BRIEF DESCRIPTION OF THE DRAWINGS

FIG. 1 is a dataflow diagram of a system for dynamically generating advertisement bid pricing data according to one embodiment of the present invention; and

FIG. 2 is a flowchart of a method performed by the system of FIG. 1 according to one embodiment of the present invention.

### DETAILED DESCRIPTION

Embodiments of the present invention are directed to a computer system which dynamically generates pricing data, such as bid floor prices and/or bid prices, for advertisement placement opportunities based on attributes of inventory sources (e.g., televisions and computers) for delivering advertisements to those advertisement placement opportunities. An example of such attributes is one or more attributes of the content currently being delivered by the inventory sources. The computer system enables such pricing data to more accurately reflect the value of the environment for placing advertisements.

Embodiments of the present invention take into account attributes of the advertisement placement opportunity, such as the position of a screen-based (e.g., television or online) advertisement placement opportunity, when calculating pricing data (such as a bid floor price or bid price) for that advertisement placement opportunity. For example, embodiments of the present invention may dynamically adjust such pricing data for an advertisement placement opportunity based on the position of the placement on a screen.

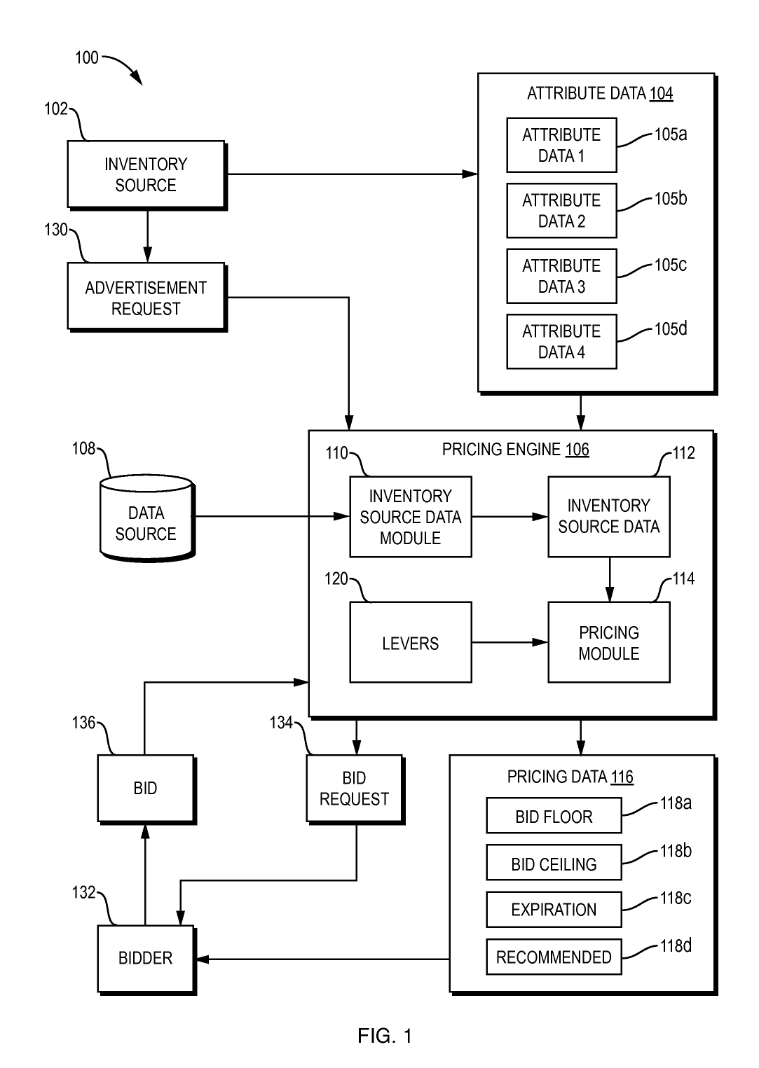

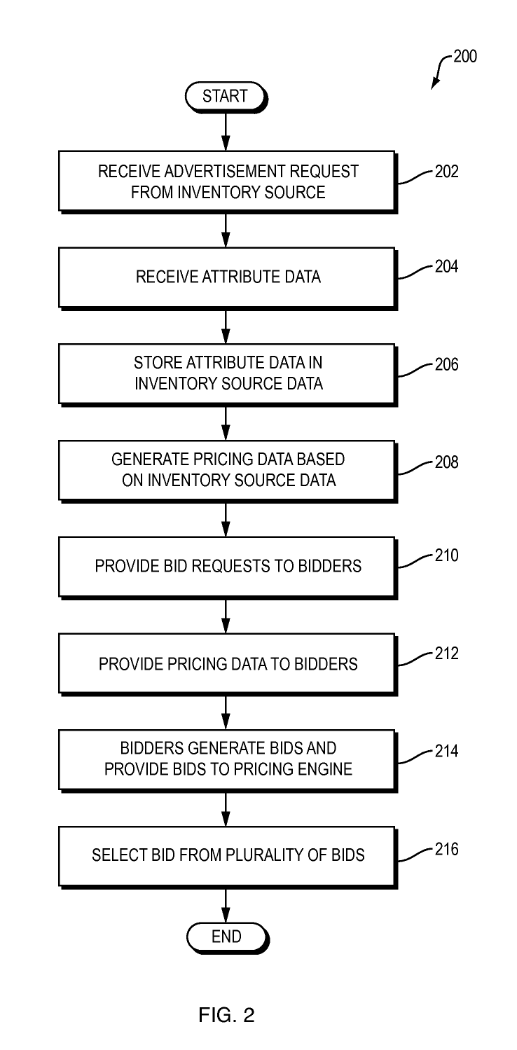

For example, referring to FIG. 1, a dataflow diagram is shown of a system 100 for dynamically generating pricing data (e.g., bid floor prices and/or bid prices) for advertisement placement opportunities according to one embodiment of the present invention. Referring to FIG. 2, a flowchart is shown of a method 200 performed by the system 100 according to one embodiment of the present invention.

The system 100 includes an inventory source 102. Examples of the inventory source 102 include a television, computer, tablet, or smartphone. These are merely examples and do not constitute limitations of the present invention. More generally, the inventory source 102 may be any device and/or medium which is capable of (e.g., contains means for) delivering an advertisement to a recipient of the advertisement (e.g., a television viewer). The inventory source 102 may, for example, be or include one or more output devices for producing output to the advertisement recipient, such as a screen for producing visual output and/or a speaker for producing auditory output. The inventory source 102 may use one or more such output devices to produce output as part of delivering the advertisement to the advertisement recipient within the advertising placement opportunity. Additionally or alternatively, the inventory source 102 may, for example, include one or more input devices for receiving input from the advertisement recipient, such as any one or more of the following: a keyboard, a touchscreen, a mouse, a track pad, and a microphone. The inventory source 102 may use such input devices to receive input as part of delivering the advertisement to the advertisement recipient, as in the case of an interactive advertisement.

The inventory source 102 may be, be a component of, or contain a computer or a computing device, as those terms are used herein. The inventory source 102 may receive data, such as advertisements, over a network, such as the public Internet or a private intranet. For example, the inventory source 102 may receive an advertisement over a network and then display some or all of the advertisement to the advertisement recipient using one or more output devices.

One or more attributes are associated with the inventory source 102. Such attributes may be represented in the form of attribute data 104 stored in a non-transitory computer-readable medium in any suitable format. Although any number of attributes may be associated with the inventory source 102, for purposes of example FIG. 1 illustrates four abstract attributes, represented by attribute data 105a-d. Examples of attributes which may be represented by attribute data 105a-d include any one or more of the following, in any combination:
a device attribute of the inventory source 102, which may include one or more of the device category of the inventory source 102 (e.g., television, desktop computer, tablet computer, smartphone), manufacturer of the inventory source 102, model number of the inventory source 102, version number of the inventory source 102, and serial number of the inventory source 102;
the mode(s) via which the inventory source 102 is capable of delivering content (e.g., text, image, video, audio, multimedia), and/or the mode(s) via which the inventory source 102 currently is delivering content;
attributes of content being delivered by the inventory source 102 at the current time or the time of one or more future placement opportunities such as:
   in the case of a television program, any one or more of the name, network, channel, genre, length, and air time of the program;
   in the case of online (e.g., web-based) content, any one or more of the URL of the web page containing the content, and the source, genre, and length of the content;
   the delivery mechanism of the content (e.g., video on demand, HTTP, linear television);
the current time;
the date and/or time of the placement opportunity;
the size, resolution, color depth, and other attributes of any screens contained within or otherwise configured to display visual output received from the inventory source 102;
the location of the user viewing the inventory source 102 (such as a current geographic location of the inventory source 102, as determined by the resolution of the IP address associated with user's Internet-connected device or from data associated with the particular user);
attributes of the user or the household viewing the inventory source 102 (such as the city of residence, television viewership load);
exposure to television or advertisement content by the user or the household viewing the inventory source 102;
the geographic location of the user;
historical transactional data including pricing for like inventory.

Some or all of the attribute data 104 associated with the inventory source 102 may change over time. For example, if the inventory source 102 is a television, then attributes related to the program being delivered by the television may change as the television delivers different programs over time. As another example, if the inventory source 102 is an Internet-connected device (such as a laptop computer or an Internet-connected television), then attributes related to the content being delivered by the Internet-connected device may change as the user of the device navigates from one web page to another or switches from one software application to another. The system 100 may store a log of the attributes as they change, so that the system 100 may access both the current attributes of the inventory source 102 and previous attributes of the inventory source 102. Such a log may be stored, for example, within the attribute data 104. As a result, the attribute data 104 may include both data representing current attributes of the inventory source 102 and data representing previous attributes of the inventory source 102.

Although only one inventory source 102 and one corresponding set of attribute data 104 is shown in FIG. 1 for ease of illustration, the system 100 may include additional inventory sources, each of which may have its own corresponding set of attributes. Therefore, any reference herein to the inventory source 102 and corresponding attribute data 104 should be understood to be equally applicable to any number of inventory sources and their corresponding attributes. Different inventory sources 102 may have different numbers and types of attributes than each other. Different inventory sources 102 sharing an attribute may have different values for that attribute at any particular time. For example, two televisions having a screen resolution attribute may have different values for that attribute. As another example, two televisions may share the same value of an attribute representing the television program being displayed at one time, while at a later time the value of that attribute may differ between the two televisions if the two televisions are displaying different programs.

Although the inventory source 102 and attribute data 104 are shown as distinct entities in FIG. 1, it should be appreciated that the inventory source 102 and attribute data 104 may be associated with each other in any way which makes it possible for the inventory source 102 and other components of the system 100 to use the attribute data 104 in connection with the inventory source 102. For example, the attribute data 104 may be stored within the inventory source 102 itself, such as in a hard drive or other memory within the inventory source 102. Even if the attribute data 104 are not stored within the inventory source 102, the attribute data 104 may be stored in a manner which makes the attribute data 104 available to the bidder, such as on a server that is accessible to the bidder. If the inventory source 102 sends a request 130 for an advertisement to an advertisement source such as an advertisement server (not shown) (such as an advertisement source containing, contained within, or otherwise in communication with the pricing engine 106), the inventory source 102 may communicate some or all of the attribute data 104 to the advertisement source (e.g., within the request 130) to assist in selecting and/or formatting an advertisement for delivery to the inventory source 102.

The system 100 also includes an advertisement pricing engine 106. The pricing engine 106 may, for example, be part of or otherwise operate in conjunction with an advertisement source (not shown). As a result, when the inventory source 102 provides some or all of the attribute data 104 to the advertising source as part of the request 130 for an advertisement, the pricing engine 106 may receive the provided attribute data 104 as part of the request 130. In general, any function disclosed herein as being performed by the pricing engine 106 should be understood to be capable of being performed solely by the pricing engine 106 or by the pricing engine 106 in combination with one or more other components, such as the advertisement source mentioned above.

In FIG. 1, the inventory source 102 is shown as providing the attribute data 104 to the pricing engine 106 because the inventory source 102 may provide some or all of the attribute data 104 to the pricing engine 106 distinctly from providing the request 130 for an advertisement. Furthermore, the pricing engine 106 may receive some or all of the attribute data 104 from a source other than the inventory source 102. The attribute data 104 may be pushed to the pricing engine 106 (e.g., by the inventory source 102 as part of the request 130 for an advertisement), pulled by the pricing engine 106 (e.g., provided by the inventory source 102 to the pricing engine 106 in response to a request from the pricing engine 106), or a combination thereof.

In general, the pricing engine 106 may receive the request 130 from the inventory source 102 for an advertisement (FIG. 2, operation 202). The pricing engine 106 receives the inventory source attribute data 104 (FIG. 2, operation 204). Note that the pricing engine 106 may receive the attribute data 104 before receiving the request 130 from the inventory source 102, as part of the request 130 from the inventory source 102, or after (e.g., in response to) receiving the request 130 from the inventory source 102.

The pricing engine 106 may store some or all of the attribute data 104 it receives in an inventory source data store 112 (FIG. 2, operation 206). The pricing engine 106 may store data identifying the inventory source 102 in association with the attribute data 104 so that the attributes for different inventory sources can be distinguished from each other. As the pricing engine 106 receives changing attribute data 104 from the inventory source 102 over time (e.g., data representing changing values of one or more attributes of the inventory source 102 over time), the pricing engine 106 may store some or all of such historical attribute data in the inventory source data store 112. Additionally or alternatively, the pricing engine 106 may derive other data from the data stored in the inventory source data store 112 (such as aggregate data) and store the derived data in the inventory source data store 112.

For example, the pricing engine 106 may use information contained within the inventory source data store 112 (e.g., the attribute data 104) to obtain additional data from a data source 108, and then store that additional data, and/or data derived from the additional data, in the inventory source data store 112. For example, information in the attribute data 104 about content being delivered by the inventory source 102 (e.g., a television program being delivered by a television) may be used by the inventory source data module 110 to obtain additional information about that content (e.g., program title, category, rating, air date) from the data source 108, and then to store that additional data in the inventory source data store 112. As another example, the inventory source data module 110 may use data in the attribute data 104 to identify the current consumer (e.g., user or household) of the content being provided by the inventory source 102 to obtain additional information about that consumer (e.g., number of children, household income, race) from the data source 108, and to store the data obtained about that user/household in the inventory source data 112. In this way, the system 100 may build data pools to aggregate behavioral and environmental data in association with individual inventory sources, such as the inventory source 102.

The pricing engine 106 includes a pricing module 114, which may use the inventory source data 112 (such as the attribute data 104 contained within the inventory source data) to dynamically calculate pricing data 116 for use in connection with buying and/or selling placement opportunities (FIG. 2, operation 208). For example, if the inventory source 102 requests an advertisement via the advertisement request 130, the pricing module 114 may generate the pricing data 116 for use in connection with pricing of the requested advertisement. The pricing module 114 may generate the pricing data 116 in response to the advertisement request 130.

The pricing engine 106 may provide a bid request 134 to one or more bidders (FIG. 2, operation 210). Although only a single bidder 132 is shown in FIG. 1 for ease of illustration, the pricing engine 106 may provide the bid request 130 to any number of bidders. Therefore, any reference herein to “the bidder 132” should be understood to refer to any number of bidders, and any reference herein to “a bid” should be understood to refer to any number of bids generated by such bidders.

The bid request 134 may, for example, include some or all of the inventory source data 112 (such as the attribute data 104 of the inventory source 102) for use by the bidder 132 in generating a bid. Furthermore, the pricing engine 106 may, but need not, provide some or all of the pricing data 116 to the bidder 132 (FIG. 2, operation 212).

If the pricing engine 106 outputs the pricing data 116 to the bidder 132, the pricing engine 106 may do so in any manner. Embodiments of the present invention may use any suitable technique to conduct an auction or other purchasing process for the advertisement based on the pricing data 116.

The pricing data 116 may, for example, include any one or more of the following:
a floor price 118a;
a ceiling price 118b;
an expiration time 118c; and
a recommended price 118d.

The pricing module 114 may generate the pricing data 116 based on some or all of the inventory source data 112, using any suitable formula, algorithm, or other process. As one simple example, the pricing engine 106 may include a set of levers 120, which may, for example, represent weights, each of which is associated with one or more particular units of data (e.g., attribute) in the inventory source data 112. The pricing module may calculate one or more of the elements of the pricing data 116 (e.g., the floor price 118a) as a linear combination of the data elements (e.g., attribute data 104), with the weights specified by the levers 120.

As described above, the attribute data 104 may take a wide variety of forms. As a result, the pricing module 114 may generate the pricing data 116 in a wide variety of ways. As a few examples, the pricing module 114 may generate some or all of the pricing data 116 (e.g., the floor price 118a) based on one or more of the following:
a location associated with the inventory source 102, such as a position associated with a particular set of coordinates or a particular region constituting a subset of a screen contained within or otherwise associated with the inventory source 102;
an attribute from which the location of the user can be inferred, such as IP Address or an attribute that communicates the location, such as zip code or state;
a time associated with the inventory source 102, such as a particular time or a particular range of times;
characteristics of one or more users associated with the inventory source 102, such as user viewing behaviors (e.g., television programs watched, amount of time spent watching television in total or during a particular time period);
a feed provider associated with the inventory source 102 (such as a television network, channel, or service provider);
decay between ad exposure instances (i.e., the amount of time between the current advertisement opportunity and the last time the current user of the inventory source 102 saw an advertisement);
characteristics of the location of the inventory source 102 (e.g., rural vs. suburban, densely populated vs. spares, proximity to major retailers); and
characteristics of the current user of the inventory source 102 (e.g., male, college-educated, in market for new car).

As the description above makes clear, differences in values in the inventory source data 112 may result in differences in the pricing data 116. For example, if the inventory source data 112 specifies one location (e.g., screen position), the pricing module 114 may generate pricing data 116 representing a first price (e.g., a first price floor 118a), while if the inventory source data 112 specifies a different location (e.g., a different screen position), the pricing module 114 may generate pricing data 116 representing a second price (e.g., a second price floor 118a) that differs in value from the first price. In other words, the pricing module 116 may generate different prices depending on the values of the inventory source data 112 and/or the values of the levers 120.

The bidder 132 may generate bid data 136 representing a bid price, and provide the bid data 136 to the pricing engine 106, which receives the bid data (FIG. 2, operation 214). Each of a plurality of bidders may generate and provide its own bid data, representing distinct bid prices, to the pricing engine 106 or, more generally, to an advertising server or other bid evaluation component, which may evaluate the bids represented by the received bid data and select one of those bids in any manner (such as by selecting the bid with the highest price) (FIG. 2, operation 216). The advertising server or other component may receive an advertisement from the selected bidder and provide the received advertisement to the inventory source.

The bid data 136 may include data representing a bid price, which the bidder 132 may calculate in any of a variety of ways. For example, the bidder 132 may include a pricing module which includes some or all of the features described herein with respect to the pricing engine 106. As a result, the bidder 132 may use any of the techniques disclosed herein for use by the pricing engine 106 to calculate the bid price that is included in the bid data 136. For example, the bidder 132 may use some or all of the inventory source data 112 (e.g., the attribute data 104 of the inventory source 102) to calculate the bid price that is included in the bid data 136. Once the bidder 132 has generated the bid data 136, the bidder 136 may provide some or all of the bid data 136 to the pricing engine 106, advertising server, or other component in any of the ways disclosed herein.

Dynamic pricing data (e.g., floor prices and bid prices) of the kind generated by the pricing engine 106 have a variety of advantages. In general, dynamic prices benefit the inventory source by properly valuing the inventory source based on the merits and attributes of that inventory source rather than based on static settings across broad classes of generally similar inventory sources. Dynamic pricing also benefits inventory suppliers by preventing bidding parties from modifying their bid amounts across many types of inventory sources in order to find the minimal price point (also known as “price discovery”).

The system 100 also enables the inventory owner or bidder to adjust the levers 120 to further customize the process used by the pricing engine 106 to calculate the pricing data 116 based on the needs of the inventory owner. Any of the levers 120 may be adjusted to make that lever have either a more or less significant effect on the calculation of the pricing data 116.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A method performed by at least one computer processor, the method comprising:
(A) receiving, from an attribute source, data representing at least one attribute of an inventory source for delivering an advertisement to a recipient of an advertisement placement opportunity; and
(B) generating pricing data for the advertisement placement opportunity based on the at least one attribute of the inventory source.

2. The method of claim 1, wherein the pricing data comprises data representing a bid floor price for the advertisement placement opportunity.

3. The method of claim 1, wherein the pricing data comprises data representing a bid price for the advertisement placement opportunity.

4. The method of claim 1, wherein the at least one attribute comprises an attribute of content being delivered by the inventory source.

5. The method of claim 1, wherein the at least one attribute comprises a location of the advertisement placement opportunity.

6. The method of claim 5, wherein the location comprises an onscreen position of the advertisement placement opportunity.

7. The method of claim 1, wherein the at least one attribute comprises a device category of the inventory source.

8. The method of claim 1, wherein the at least one attribute comprises a mode via which the inventory source is capable of delivering content.

9. The method of claim 1, wherein the at least one attribute comprises an attribute of a screen for displaying visual output from the inventory source.

10. The method of claim 1, wherein the at least one attribute comprises a location of the recipient of the advertisement.

11. The method of claim 1, wherein the inventory source comprises a television.

12. The method of claim 1, wherein the inventory source comprises a computer.1

13. The method of claim 1, wherein the attribute source comprises the inventory source, and wherein receiving the data representing the at least one attribute of the inventory source comprises receiving, from the inventory source, the data representing the at least one attribute of the inventory source.

14. The method of claim 1, wherein (A) comprises receiving the data representing the at least one attribute of the inventory source within a request for an advertisement.

15. The method of claim 1, further comprising:
(C) providing the pricing data to a bidder.

16. The method of claim 15, wherein the pricing data comprises data representing at least one of a bid floor price for the advertisement placement opportunity, a ceiling price for the advertisement placement opportunity, an expiration time for the advertisement placement opportunity, and a recommend price for the advertisement placement opportunity.

17. The method of claim 1, wherein the pricing data comprises a bid price, and wherein the method further comprises:
(C) providing the pricing data to a bid evaluation component.

18. A non-transitory computer-readable medium comprising computer program instructions executable by at least one computer processor to perform a method, the method comprising:
(A) receiving, from an attribute source, data representing at least one attribute of an inventory source for delivering an advertisement to a recipient of an advertisement placement opportunity; and
(B) generating pricing data for the advertisement placement opportunity based on the at least one attribute of the inventory source.

19. The non-transitory computer-readable medium of claim 18, wherein the pricing data comprises data representing a bid floor price for the advertisement placement opportunity.

20. The non-transitory computer-readable medium of claim 18, wherein the pricing data comprises data representing a bid price for the advertisement placement opportunity.

21. The non-transitory computer-readable medium of claim 18, wherein the at least one attribute comprises an attribute of content being delivered by the inventory source.

22. The non-transitory computer-readable medium of claim 18, wherein the at least one attribute comprises a location of the advertisement placement opportunity.

23. The non-transitory computer-readable medium of claim 22, wherein the location comprises an onscreen position of the advertisement placement opportunity.

24. The non-transitory computer-readable medium of claim 18, wherein the at least one attribute comprises a device category of the inventory source.

25. The non-transitory computer-readable medium of claim 18, wherein the at least one attribute comprises a mode via which the inventory source is capable of delivering content.

26. The non-transitory computer-readable medium of claim 18, wherein the at least one attribute comprises an attribute of a screen for displaying visual output from the inventory source.

27. The non-transitory computer-readable medium of claim 18, wherein the at least one attribute comprises a location of the recipient of the advertisement.

28. The non-transitory computer-readable medium of claim 18, wherein the inventory source comprises a television.

29. The non-transitory computer-readable medium of claim 18, wherein the inventory source comprises a computer.

30. The non-transitory computer-readable medium of claim 18, wherein the attribute source comprises the inventory source, and wherein receiving the data representing the at least one attribute of the inventory source comprises receiving, from the inventory source, the data representing the at least one attribute of the inventory source.

31. The non-transitory computer-readable medium of claim 18, wherein (A) comprises receiving the data representing the at least one attribute of the inventory source within a request for an advertisement.

32. The non-transitory computer-readable medium of claim 18, further comprising:
(C) providing the pricing data to a bidder.

33. The non-transitory computer-readable medium of claim 32, wherein the pricing data comprises data representing at least one of a bid floor price for the advertisement placement opportunity, a ceiling price for the advertisement placement opportunity, an expiration time for the advertisement placement opportunity, and a recommend price for the advertisement placement opportunity.

34. The non-transitory computer-readable medium of claim 18, wherein the pricing data comprises a bid price, and wherein the method further comprises:
(C) providing the pricing data to a bid evaluation component.
